(19) United States
(12) Patent Application Publication
(10) Pub. No.: US 2017/0348864 A1
(43) Pub. Date: Dec. 7, 2017

(54) SAFETY KNIFE FOB APPARATUS

(71) Applicant: Robert Harrington, Asheville, NC (US)

(72) Inventor: Robert Harrington, Asheville, NC (US)

(21) Appl. No.: 15/731,318

(22) Filed: May 24, 2017

Related U.S. Application Data
(60) Provisional application No. 62/392,446, filed on Jun. 2, 2016.

(51) Int. Cl. B26B 11/00

(52) U.S. Cl. CPC B26B 11/00

(57) ABSTRACT

A fob for a key chain, lanyard, or the like, supports a razor blade, or other knife blade suitable for cutting through relatively thin articles. The razor blade is embedded within the interior of a substantially rectangular-shaped molded plastic housing or casing defining the fob casing. The fob casing includes a slot intercepting one short side and the razor blade embedded inside the fob casing is positioned so that its sharpened blade edge intercepts the slot at an angle a distance from the mouth or opening of the slot. A suitable opening is included in the fob casing to support a key ring, lanyard, or other supporting axillary device.

### RELATED APPLICATION

The present application claims priority for all purposes on and of my prior provisional application, Ser. No. 62/392,446, filed Jun. 2, 2016, entitled: Safety Knife Fob Apparatus. To perfect this claim, a duly executed Application Data Sheet under 37 CFR 1.76 is being filed concurrently with this application. The aforementioned, prior pending provisional application, Ser. No. 62/392,446, etc. and the Application Data Sheet hereby are incorporated in and made part of this application.

### BACKGROUND OF THE INVENTION

### Field of the Invention

The present invention relates generally to utility knives, and more particularly, to a novel safety knife or cutting tool comprising a razor blade embedded in a housing, which latter may be a key-chain fob.

### Description of the Prior Art

It is well known in the art to provide so-called “utility knives” generally characterized by a razor blade mounted in or carried by a handle. Because at various times the razor blade, or a portion thereof, extends out from the handle during use, such knives inherently are dangerous capable of causing accidents or injury.

The following U.S. prior art patents are typical of utility knives which comprise a razor blade or the like supported in a housing or outer casing serving as the handle for the knife: U.S. Pat. No. 2,788,574 (Marcmann); U.S. Pat. No. 4,139,939 (Crooks); U.S. Pat. No. 4,320,576 (Beermann); U.S. Pat. No. 4,748,743 (Anderson et al); U.S. Pat. No. 4,939,839 (Gorst); U.S. Pat. No. 5,337,482 (Schmidt); and Des. 336,029 (Ragland et al).

A clear need exists for a “safety” utility knife having a razor blade or other cutting member which is not dangerously exposed during use. That need is met by the present invention. Accordingly, a primary object of the present invention is the provision of a safety knife featuring a razor blade cutting tool mounted in a housing member where the sharp edge of the blade or tool is not dangerously exposed during use. Another object of the present invention is the provision of a blade housing or casing serving the dual function of a key-chain fob thereby enhancing ready access to the utility knife of the invention.

### SUMMARY OF THE INVENTION

To achieve the foregoing and other objects and advantages, the present invention, briefly summarized, provides a fob for a key chain, lanyard, or the like, where the fob supports a razor blade, or other knife blade, for cutting through relatively thin articles such as a seat belt strap, fabric clothing, plastic handcuff restraint, cardboard, paper, or the like. Preferably, the razor blade is embedded within the interior of a substantially rectangular-shaped molded plastic housing or casing. The fob casing includes a slot intercepting one short side and the razor blade embedded inside the casing is positioned so that its sharpened blade edge intercepts the slot at an angle a distance from the mouth or opening of the slot. In this manner the blade is recessed and thereby prevented from accidentally injuring the user. To use the fob-supported knife of the invention, the edge of the article being cut is received through the mouth or opening of the slot to engage the angled blade edge. Axial tension then is placed on the fob to cause the slot and the blade edge to move across or relative to the article in the slot thereby causing cutting of the article in a direction generally aligned with the slot.

A suitable opening is included in the fob casing to support a key ring, lanyard, or other supporting axillary device. The fob according to the present invention is so inexpensive to fabricate, after several uses and consequent dulling of the blade, it merely may be thrown away, preferably to be recycled. The fob apparatus serves conveniently as a safe cutting appliance, or novelty, and additionally may have indicia such as a logo printed thereon to enhance its appeal or ornamental appearance.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a schematic perspective taken from above right showing the fob of the invention in use cutting an article.

FIG. 2 is an enlarged front view in elevation of the preferred embodiment of the invention shown in FIG. 1.

FIG. 3 is a top plan view taken along line 3-3 in FIG. 2.

FIG. 4 is an enlarged side or end view taken along line 4-4 in FIG. 2.

FIG. 5 is an enlarged cross-sectional view taken along line 5-5 in FIG. 4.

### DESCRIPTION OF THE PREFERRED EMBODIMENTS

With reference to the drawings, a new and improved safety knife fob apparatus embodying the principles and concepts of the present invention will be described.

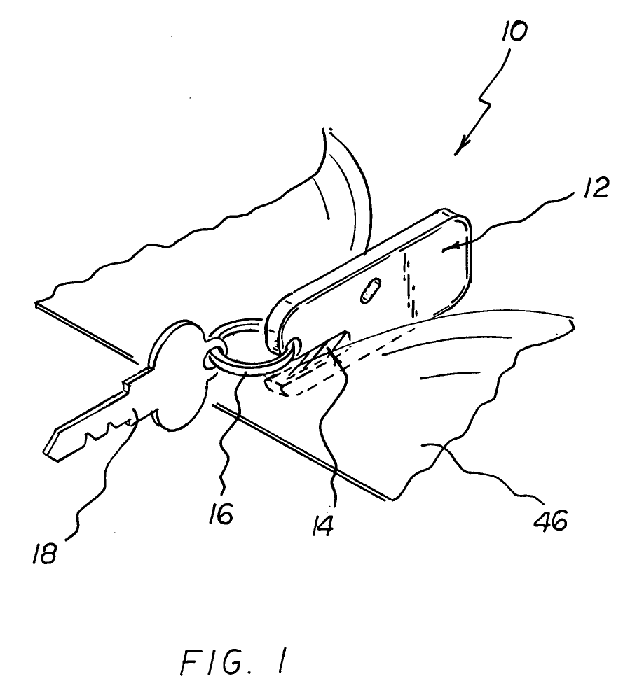

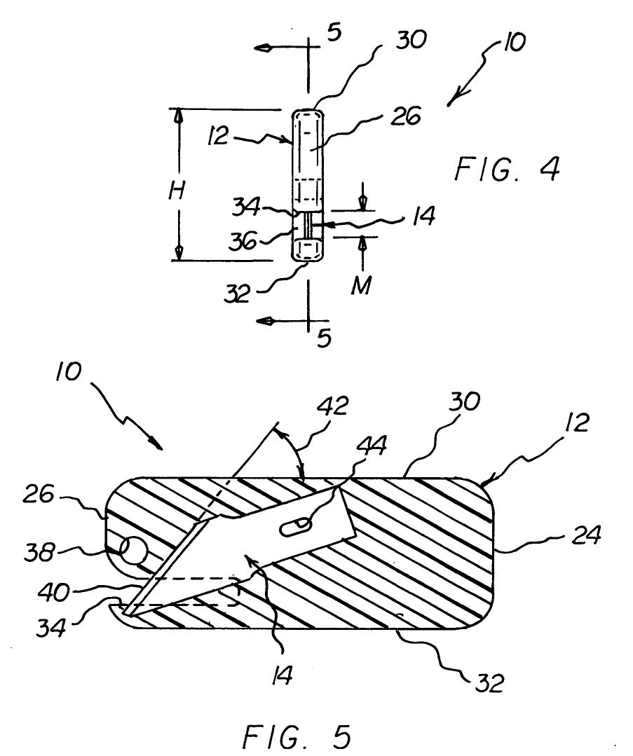

Turning to FIGS. 1-5, there is shown a preferred embodiment of the safety knife fob apparatus of the invention generally designated by reference numeral 10. In each of the figures, reference numerals are shown that correspond to like reference numerals that designate like elements shown in other figures.

In the preferred embodiment, safety knife fob apparatus 10 comprises a substantially solid fob body member 12, and a razor blade or other cutting blade 14 embedded within and supported by the fob body member 12. Preferably, a conventional key ring 16 is suitably connected to the fob body member 12 and a key 18 or the like, in turn, is connected to the key ring 16 (FIG. 1).

Preferably, fob body member 12 comprises a substantially rectangular-shaped prism having a front face 20, a rear face 22, a right end 24, a left end 26, a top end 30, and a bottom end 32, substantially as depicted. A slot 34, preferably of rectangular cross-sectional shape, extends from left end 26 substantially parallel to the imaginary longitudinal centerline or axis of body member 12 ultimately terminating in an end wall or “blind end” 36 recessed with respect to left end 26. Slot 34 thus also has an imaginary central longitudinal axis extending substantially parallel to the imaginary central axis of fob body member 12, and substantially parallel to top end 32 and bottom end 34 of body member 12. In accordance with the invention, slot 34 defines a convenient entrance mouth or opening in left end 26 for receiving the edge of an article to be cut by blade 12 (FIG. 1).

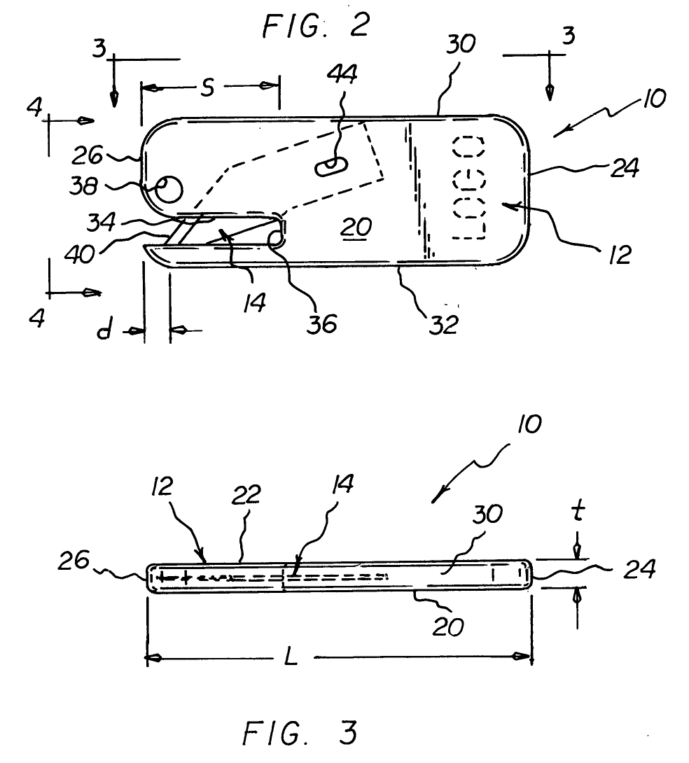

Substantially as depicted in the FIGS. 2-4, fob body member 12 has a longitudinal extent or length “L,” a height “H,” and a thickness “t” whereas slot 34 has a longitudinal extent or length “S,” and a height “M.” Hence, the size of the mouth opening of cutting slot 34 in left end 26 is “M”×“t.”

A thru opening 38, preferably circular in shape, is located proximal to left end 26 and slot 34, substantially as depicted. Preferably, the center of opening 38 is aligned with the imaginary longitudinal axis or centerline (not shown) of fob body member 12 as viewed in FIG. 2. The purpose of opening 38 is to provide an anchoring means on fob body member 12 for key ring 16 (FIG. 1), or other similar appliance such as a lanyard, for example.

Preferably razor blade 14 is transversely positioned interiorly of the fob body member housing substantially centrally thereof (FIG. 3), and as best seen in FIG. 5, the embedded razor or cutting blade 14 is so positioned within the fob body member 12 such that its tip is pointed down and to the left as it intercepts and transcends slot 34 with the tip of the blade ultimately being received in the portion of the fob body extending below slot 34. By this arrangement, it will be observed that the sharpened cutting edge 40 of blade 14 extends at an acute angle with respect to the imaginary central longitudinal axis of the fob body member 12 as indicated by arrow 42 (FIG. 5). Moreover, the “effective length” of the angled cutting edge 40 of blade 12 within the compass of slot 34 is enhanced, and the cutting edge 40 per se always is recessed within slot 34 a minimum distance “d” with respect to left end end 26 (FIG. 2). Because angled blade 12 is always so recessed within slot 34, accidental injuries (cut or nicked fingers) to a user under virtually all use conditions of the apparatus 10 are eliminated.

To fabricate the safety knife fob apparatus 10 of the invention, it is preferred to place razor blade 12 in a suitable mold cavity and to subsequently injection mold a suitable polymer around the blade as will occur to those of ordinary skill. The preferred polymer is a polyamide with glass-filled nylon being mostly preferred. Oblong opening 44 which passes through both the blade 14 and fob body member 12 can be used to receive a pin in the mold cavity suitable to maintain the blade in position as the polymer is molded about the blade. Finally, it will be appreciated that razor or cutting blade 14 can be fabricated in a known manner preferably of machined steel.

In use, referring to FIG. 1, the safety knife fob apparatus 10 can be used conveniently to cut many different articles 46 by causing the fob body member 12 to advance in the direction of the desired cut after the edge of the article is received in the slot 34 of the fob member 12. Cutting action is enhanced by grasping the key 18, the key ring 16, along with the fob body member 12 and applying tension or a pulling force in the desired direction of the cut. It will be appreciated that many different articles may be severed with the invention in an expedient manner such as seat belts webs, handcuff restraints, articles of clothing, paper containers, or cardboard, just to name a few examples.

To further illustrate the invention without limiting same, the following dimensions and materials have been used in producing prototypical examples of the safety knife fob apparatus of the invention:
Fob length: 2.5 in.
Fob height: 1.0 in.
Fob thickness: 0.190 in.
Slot length: 0.90 in.
Slot height: 0.014 in.
Blade recess: 0.20 in.
Blade angle: 60°
Exposed length of blade in slot: 0.650 in.
Fob housing material: glass-filled nylon (polyamide)
Blade material: steel
Weight of Fob w/Blade: 11 grams
Diameter of Key Ring Opening: 0.25 in.

To summarize the many benefits or advantages of the unique safety knife fob apparatus of the invention, the latter may be carried conveniently as a key ring or on a lanyard and used especially in a an emergency to cut through seat belts straps, plastic handcuff restraints, clothing, cardboard packaging or boxes, or the like. The safety knife fob apparatus is relatively small in size, light in weight, and inexpensive to fabricate. Because of the provision of a thru-opening, keys or a lanyard easily can be attached to the fob member and then grasped during cutting actions to provide increased leverage thereby making cutting easier and more rapid. Because of the manner in which the blade is angled with respect to the cutting slot of the fob member, the recessed blade length is enhanced sufficient to cut relatively thick objects such as seat belt straps and plastic handcuff restraints. The flat end or bottom of the fob member provides a convenient surface to facilitate pushing of the fob member during cutting actions. The recessed blade construction characterized by the fob member housing or casing permits the fob member apparatus to be conveniently carried in one's pocket without accidentally causing cutting or nicking of the fingers. And finally, the thickness and strength of the molded plastic housing completely surrounding the razor or cutting blade affixed interiorly thereof, affords a relatively strong and durable fob member that resists breakage and prevents the cutting blade from easily being broken out and used separately (i.e. the invention is “childproof”).

Hence, the proper scope of the present invention should be determined only by the broadest interpretation of the appended claims so as to encompass all such modifications as well as all relationships equivalent to those illustrated in the drawings and described in the specification.

What is claimed as being new and desired to be protected by Letters Patent of the United States is as follows:

1. Apparatus for supporting a sharpened blade suitable for cutting through various articles, said apparatus comprising in combination:
a housing,
a cutting blade, said cutting blade having at least one sharpened cutting edge,
said housing comprising a substantially solid body member, said body member being characterized by first and second opposed longitudinally extending side edges, first and second opposed transverse end edges, a front face and a rear face, and a thickness dimension extending between said front face and said rear face,
said cutting blade being embedded within the interior of said body member between said front face and said rear face.
said body member further including a slot extending from said first transverse end edge toward said second transverse end edge between said front face and said rear face of said body member, said slot terminating in said body member intermediately between said first and second transverse end edges to define a slot blind end located between said first and second transverse end edges of said body member,
said cutting blade including said at least one sharpened cutting edge being positioned within said interior of said body member such that said at least one sharpened cutting edge of said cutting blade intercepts and transcends said slot a distance spaced from said first transverse end edge and extends into and across said slot proximal to said slot blind end.

2. The apparatus of claim 1 wherein said slot intercepts said front face and said rear face of said body member and intercepts said first transverse end edge of said body member to define a slot opening in said first transverse end edge, said at least one sharpened cutting edge of said cutting blade being positioned within said interior of said body member such that said at least one sharpened cutting edge of said cutting blade is spaced a distance “d” from said first transverse end edge slot opening.

3. The apparatus of claim 2 wherein said slot extending from said first transverse end edge toward said second transverse end edge between said front face and said rear face of said body member extends substantially parallel and longitudinally with respect to said first and second opposed longitudinally extending side edges of said body member.

4. The apparatus of claim 3 wherein said slot has an imaginary longitudinal axis, and said at least one sharpened cutting edge of said cutting blade positioned within said interior of said body is spaced a distance “d” from said first transverse end edge, and wherein said distance “d” is measured along said imaginary longitudinal axis of said slot between said first transverse end edge of said body member and said at least one sharpened cutting edge of said cutting blade positioned within said interior of said body member and
wherein said at least one sharpened cutting edge of said cutting blade intercepting and transcending said slot extends at an acute angle with respect to said slot imaginary longitudinal axis.

5. The apparatus of claim 4 wherein said acute angle is about 60°.

6. The apparatus of claim 1 wherein said body member includes a passageway through said front face and said rear face for receiving a key ring whereby said body member serves the dual function of a key-ring fob.

7. The apparatus of claim 6 wherein said body member comprises a substantially rectangular-shaped prism having a length of about 2.5 inches, a height of about 1.0 inches, a thickness of about 0.190 inches, and wherein said distance “d” along said longitudinal extent of said slot is about 0.20 inches.

8. The apparatus of claim 7 wherein said slot is substantially rectangular in cross-sectional shape and has slot height of about 0.014 inches and a slot width substantially equal to the thickness dimension of said body member.

9. The apparatus of claim 8 wherein the effective length of said sharpened edge of said cutting blade intercepting and transcending said slot and extending at an acute angle of about 60° with respect to said slot imaginary longitudinal axis has an effective length of about 0.650 inches.

10. The apparatus of claim 1 wherein said housing body member comprises a polymer molded about said cutting blade, said polymer comprising a glass-filled polyamide (nylon).

11. A key-ring fob comprising:
a substantially rectangular-shaped prism said prism having first, second, third and fourth end edges,
a razor blade having a sharpened edge embedded within said prism,
a material-receiving slot in said prism extending from one of said first, second, third or fourth end edges toward one or more of the other of said end edges, and
wherein said embedded razor blade is positioned within said prism such that said embedded razor blade's sharpened edge transcends and intercepts said slot and is spaced inwardly along said material-receiving slot within said prism with respect to said one of said first, second, third or fourth end edges.
